(19) United States
(12) Patent Application Publication
(10) Pub. No.: US 2023/0088900 A1
(43) Pub. Date: Mar. 23, 2023

(54) DOUBLE-SYSTEM LOCK STRUCTURE

(71) Applicant: REAL LOCKS & SECURITY CO., LTD., New Taipei City (TW)

(72) Inventor: Hsi-Hao HO, New Taipei City (TW)

(21) Appl. No.: 17/483,412

(22) Filed: Sep. 23, 2021

(51) Int. Cl. E05B 37/00; E05B 37/02

(52) U.S. Cl. CPC E05B 37/0034; E05B 37/02

(57) ABSTRACT

The disclosure relates to a lock structure. The combination lock mechanism includes multiple number wheels, multiple wheel cylinders, multiple wheel cylinder springs and a wheel rod. The wheel cylinder springs press between the wheel cylinders. The wheel cylinder has a plane portion and a round tab. The key lock mechanism has a lock seat and a lock core. The control sheet assembly has a lock core control sheet with multiple protrusive shafts, a support spring and multiple shaft wheels. The lock core control sheet touches the plane portion or the round tab. The support spring elastically presses the lock core control sheet. The lock core control sheet rotates about the protrusive shafts to engage with the lock seat when touching the round tab.

### BACKGROUND

### Technical Field

The disclosure relates to a lock, particularly to a double-system lock structure.

### Related Art

A double-system lock is a locking device which is unlocked by using both a key and numbers. A double-system lock may be unlocked by either a key or rotating number wheels to a correct sequence of numbers to actuate a lock core.

Moreover, when a double-system lock is in usage, multiple control sheets are pushed to control the operation of number wheels. A side of the control sheet is disposed with a protrusive block for holding a spring to provide elastic resilience so as to make the number wheels rotatable when an external force is exerted to unlock or change codes. However, during the process of rotation of the number wheels, the protrusive block is subject to an external force to escape from the spring and detach from predetermined position. That makes the double-system lock unable to perform number change and damaged.

In view of this, the inventors have devoted themselves to the above-mentioned related art, researched intensively and cooperated with the application of science to try to solve the above-mentioned problems.

### SUMMARY

The disclosure provides a double-system lock, the lock core control sheet is rotated through the support spring and shaft wheel to selectively engage with the lock seat. Therefore, the internal structure possesses higher stability when the combination lock is being rotated. The failure rate of the double-system lock may be reduced.

In the embodiments of the disclosure, the disclosure provides a double-system lock, which includes a lock case, a combination lock mechanism, a key lock mechanism and a control sheet assembly. The lock case has a panel and a base assembled with each other. The panel has multiple windows. The combination lock mechanism is installed on the base and includes multiple number wheels, multiple wheel cylinders penetrating through the number wheels, multiple wheel cylinder springs and a wheel rod. The number wheels are arranged spacedly and partially exposed from the windows. The wheel rod penetrates through the wheel cylinders. The wheel cylinder springs separately press between the wheel cylinders. Each wheel cylinder has a plane portion and a round tab. The key lock mechanism has a lock seat and a lock core. The lock seat is installed on the base. The lock core is inserted in the lock seat and selectively drives the lock seat to rotate. The control sheet assembly has a lock core control sheet, a support spring, and a pair of shaft wheels. The lock core control sheet abuts against the lock seat and selectively touches the plane portion or the round tab of each wheel cylinder. The support spring elastically presses the bottom of the lock core control sheet. The lock core control sheet has a pair of protrusive shafts passing through the pair of shaft wheels. The lock core control sheet rotates about the pair of protrusive shafts to engage with the lock seat when the lock core control sheet touches the round tab of each wheel cylinder.

In comparison with related-art double-system locks whose control sheet may be damaged because the spring escapes from the protrusive block, the double-system lock structure of the disclosure is disposed with the lock core control sheet. The lock core control sheet abuts against the lock seat and selectively touches the plane portion or the round tab of the wheel cylinder. The shaft wheel is inserted by the protrusive shaft of the lock core control sheet. The support spring elastically presses the bottom side of the lock core control sheet. As a result, the lock core control sheet may rotate about the protrusive shaft and selectively engage with the lock seat. That may enhance the stability of the internal structure when the combination lock is rotated, reduce the failure rate of the double-system lock, and increase the utility of the disclosure.

### BRIEF DESCRIPTION OF THE DRAWINGS

FIG. 1 is a perspective schematic view of the double-system lock structure of the disclosure;

FIG. 2 is an exploded view of the double-system lock structure of the disclosure;

FIG. 3 is a perspective schematic view of the internal structure of the double-system lock of the disclosure;

FIGS. 4 and 5 are cross-sectional views of the internal structure of the double-system lock of the disclosure;

FIG. 6 is a schematic plan view of the double-system lock of the disclosure when the number wheels are correct;

FIG. 7 is a schematic plan view of the double-system lock of the disclosure when the number wheels are incorrect;

FIG. 8 is a perspective schematic view of the internal structure of the double-system lock of the disclosure when the number wheels are incorrect; and

FIGS. 9 and 10 are cross-sectional views of the internal structure of the double-system lock of the disclosure when the number wheels are incorrect.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

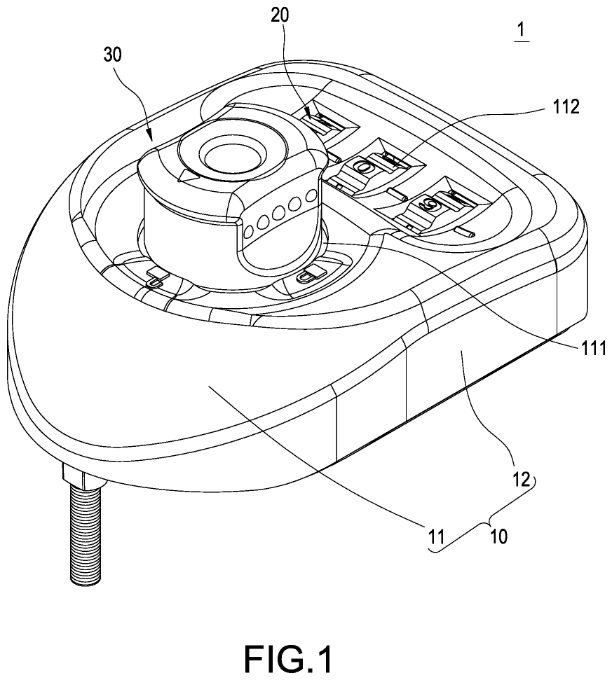

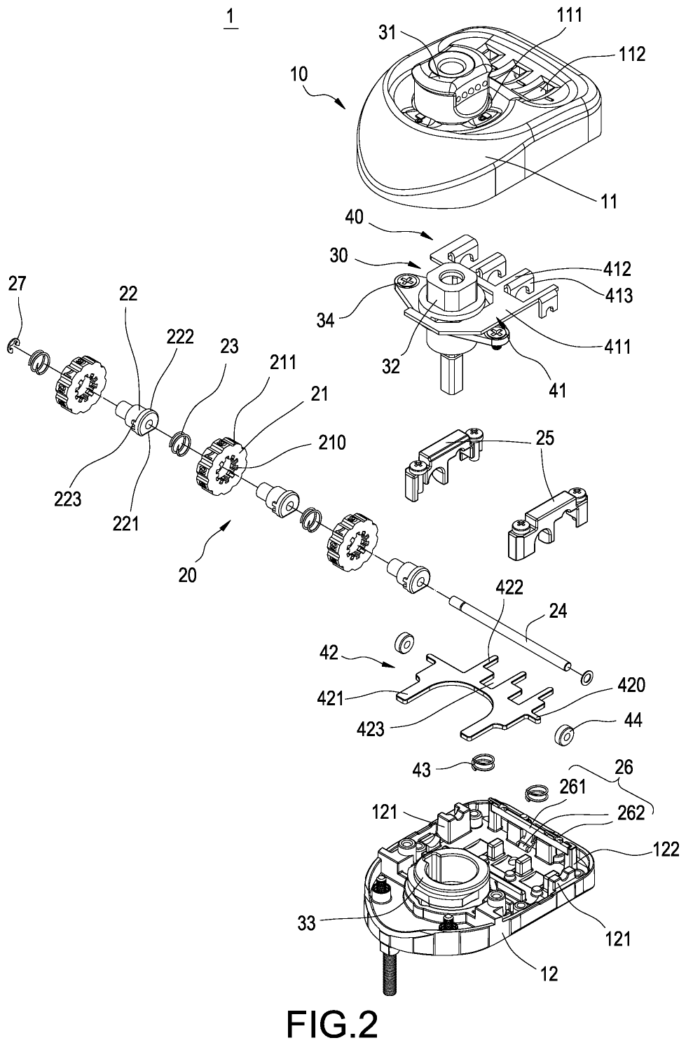

Please refer to FIGS. 1-5, which show a perspective schematic view, an exploded view, a perspective schematic view of the internal structure and cross-sectional views of the internal structure of the double-system lock of the disclosure. The disclosure provides a double-system lock 1, which includes a lock case 10, a combination lock mechanism 20 disposed in the lock case 10, a key lock mechanism 30 and a control sheet assembly 40. The control sheet assembly 40 is configured to control the combination lock mechanism 20 and the key lock mechanism 30 to provide the operations of locking/unlocking, or changing number, etc., of the double-system lock 1. The structure of the double-system lock 1 will be further described as follows.

The lock case 10 includes a panel 11 and a base 12 assembled with each other. The panel 11 has a through hole 111 and multiple windows 112.

The combination lock mechanism 20 is installed on the base 12 and includes multiple number wheels 21, multiple wheel cylinders 22 penetrating through the number wheels 21, multiple wheel cylinder springs 23 and a wheel rod 24. The number wheels 21 are arranged spacedly and partially exposed from the windows 112 of the panel 11. Each number wheel 21 has multiple slots 210. The wheel rod 24 penetrates through the wheel cylinders 22. The wheel cylinder springs 23 separately press between the wheel cylinders 22.

In detail, the base 12 has a pair of shaft seats 121. Two ends of the wheel rod 24 are disposed on the pair of shaft seats 121. In addition, the combination lock mechanism 20 further includes a pair of shaft covers 25. The pair of shaft covers 23 is fixed to the base 12 and covers two ends of the wheel rod 24.

Besides, each wheel cylinder 22 has a plane portion 221, a round tab 222 and multiple ribs 223. Each wheel cylinder 22 makes the ribs 223 selectively engage with or separate from the slots 210 of the number wheel 21 being penetrated correspondingly through the wheel cylinder springs 23.

In the embodiment, the base 12 has multiple support sheet seats 122. The combination lock mechanism 20 further includes a positioning sheet 26. The positioning sheet 26 includes an extended portion 261 and multiple claw portions 262 disposed spacedly on the opposite sides of the extended portion 261. The extended portion 261 is disposed on the support sheet seats 122. In addition, a periphery of each number wheel 21 is formed equidistantly with multiple positioning notches 211. The claw portions 262 may be selectively positioned on the positioning notches 211.

Further, the key lock mechanism 30 includes a knob 31, a lock core 32 and a lock seat 33. The knob 31 projects from the through hole 111 of the panel 11. The lock seat 33 is installed on the base 12 at a position corresponding to the knob 31. An end of the lock core 32 is connected to the knob 31, and the other end of the lock core 32 is inserted in the lock seat 33 and capable of selectively driving the lock seat 33 to rotate.

The control sheet assembly 40 includes a number control sheet 41, a lock core control sheet 42, a support spring 43 and a pair of shaft wheels 44. The number control sheet 41 abuts against the lock core 32 and selectively presses each wheel cylinder spring 23. It is noted that the pair of shaft covers 25 of the combination lock mechanism 20 also covers the pair of shaft wheels 44 to make the pair of shaft wheels 44 be positioned on the base 12.

In an embodiment of the disclosure, the number control sheet 41 includes a main pushing rod 411 surrounding the lock core 32, multiple secondary pushing rods 412 horizontally extended from a side of the main pushing rod 411 and a pushing portion 413 downward extended from each secondary pushing rod 412. The pushing portion 143 abuts against the corresponding wheel cylinder spring 23.

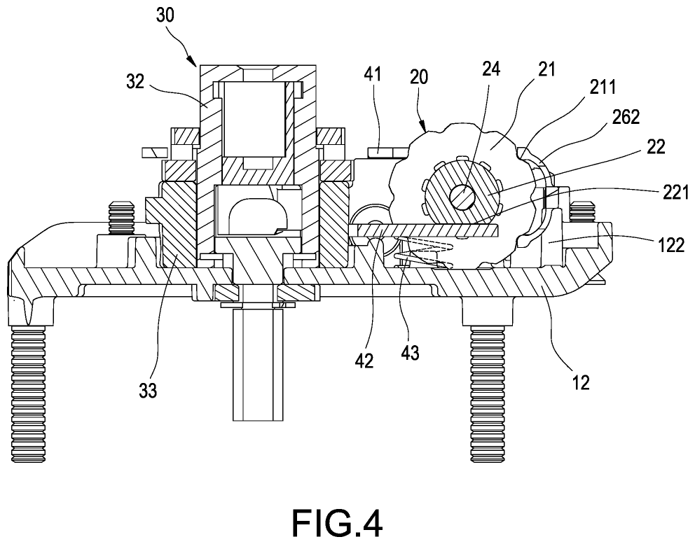

Also, the lock core control sheet 42 abuts against the lock seat 33 and selectively touches the plane portion 221 or the round tab 222 of each wheel cylinder 22. The support spring 43 is disposed in the base 12 and elastically presses the bottom of the lock core control sheet 42 as shown in FIG. 4. In addition, the lock core control sheet 42 has a pair of protrusive shafts 420 passing through the pair of shaft wheels 44. As a result, the lock core control sheet 42 is capable of rotating about the pair of protrusive shafts 420 to engage with the lock seat 33 when the lock core control sheet 42 touches the round tab 222 of each wheel cylinder 22.

In an embodiment of the disclosure, the lock core control sheet 42 includes a frame plate 421 surrounding the lock seat 33 and multiple fingers 422 horizontally extended from a side of the frame plate 421. In detail, the protrusive shaft 420 of the lock core control sheet 42 is outward extended from opposite sides of the frame plate 421. In addition, a wheel trough 423 is formed between the adjacent fingers 422 of the lock core control sheet 42. Also, each number wheel 21 is inserted in the corresponding wheel trough 423.

In the embodiment, the double-system lock 1 includes multiple support springs 43. The support springs 43 are disposed on the base 12 and elastically press the bottom of the lock core control sheet 42. The protrusive shafts 421 on two sides of the lock core control sheet 42 separately pass through the shaft wheels 44. Also, the combination lock mechanism 20 includes three number wheels 21, three-wheel cylinders 22 and three-wheel cylinder springs 23. The three-wheel cylinders 22 are correspondingly inserted in the three number wheels 21. The three-wheel cylinder springs 23 separately elastically press a side of each wheel cylinder 22 for elastically pushing each wheel cylinder 22. Three sets of number wheels 21 and wheel cylinder springs 23 arranged spacedly are passed through by the wheel rod 24 in order and are assembled on the wheel rod 24 by two pressing sheets 27 on two sides. Two ends of the wheel rod 24 are disposed on the pair of shaft seats 121. In addition, the pair of shaft covers 25 covers two ends of the wheel rod 24 and the pair of shaft wheels 44 to assemble the lock core control sheet 42 and the combination lock mechanism 20 into the base 12.

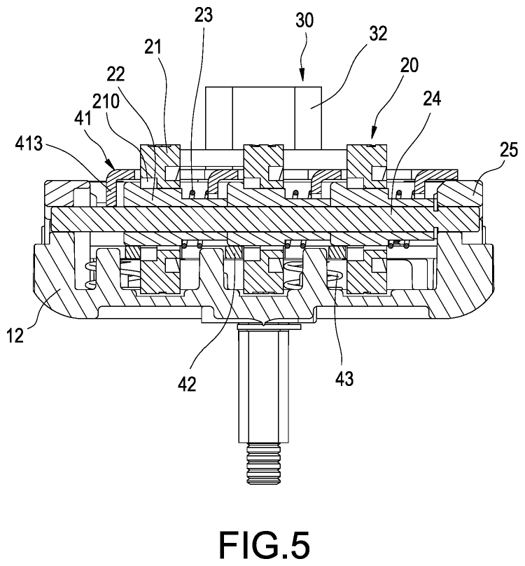

Further, the lock seat 33 is installed on the base 12, and the lock core 32 penetrates the lock seat 33. The lock core 32 is fixed to the base 12 by multiple screws 34 and is rotatable relative to the lock seat 33. In addition, the main pushing rod 411 of the number control sheet 41 surrounds the lock core 32. The secondary pushing rods 412 are correspondingly inserted between the number wheels 21 to make the pushing portions 413 downward extended from the secondary pushing rods 412 abut against a side of each wheel cylinder spring 23 as shown in FIG. 5. As a result, a user may rotate the lock core 32 with a key to unlock the double-system lock 1, or rotate the key lock mechanism 30 to the correct number combination to rotate the lock core 32 to unlock the double-system lock 1.

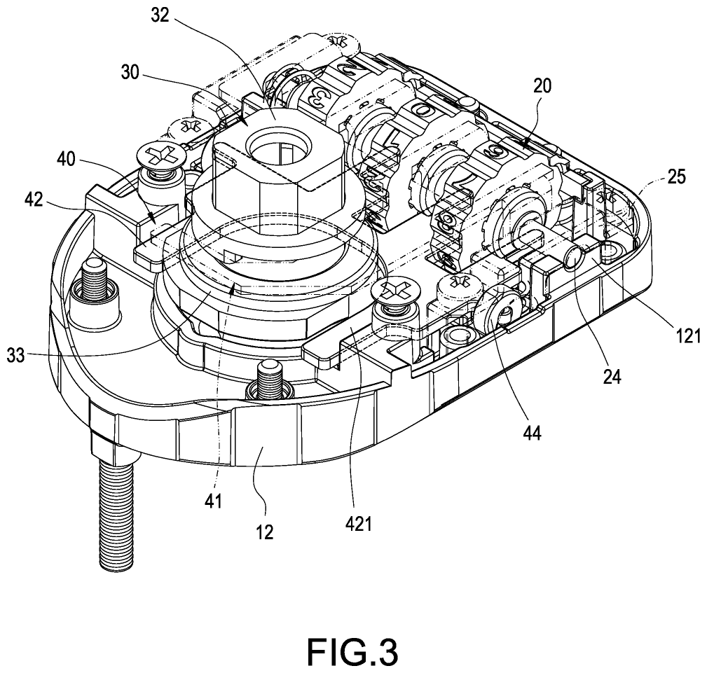

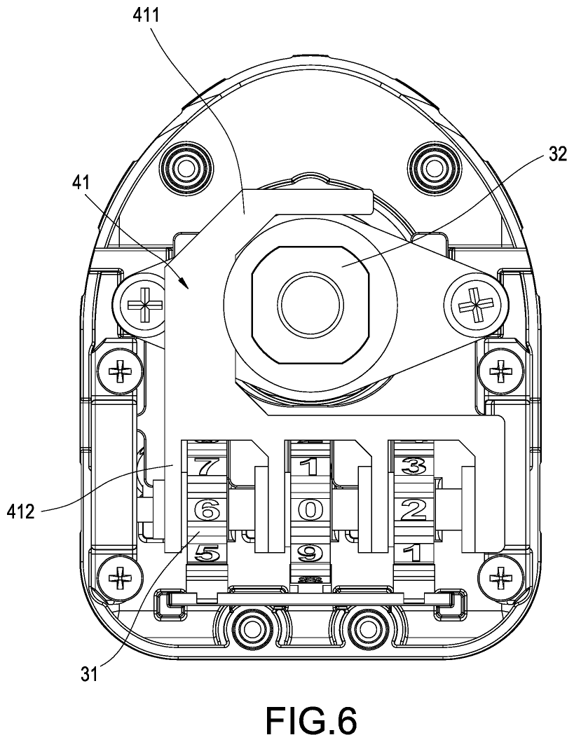

Please refer to FIG. 6, which shows a schematic plan view of the double-system lock of the disclosure when the number wheels are correct. When the number wheels 21 are rotated to the preset number combination, the plane portions 221 of the wheel cylinders 22 simultaneously touch the lock core control sheet 42 as shown in FIG. 4, the frame plate 421 of the lock core control sheet 42 is inserted outside the lock seat 33 as shown in FIG. 3, and the lock core 32 is rotatable to be unlocked. It is noted that the ribs 223 of the wheel cylinders 22 are separated from the slot 210 of the corresponding number wheel 21.

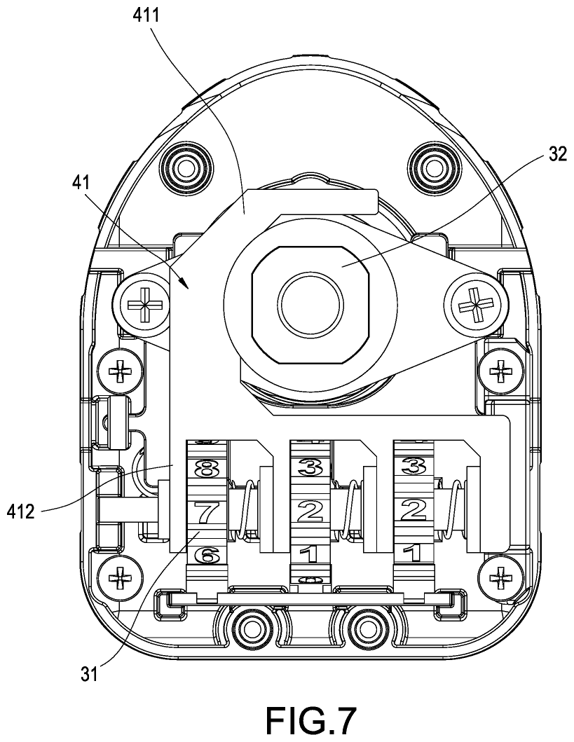

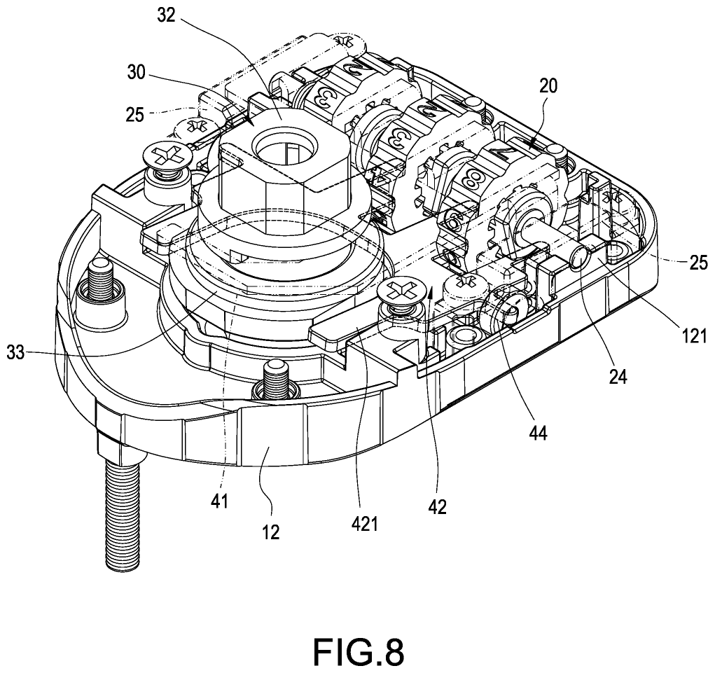

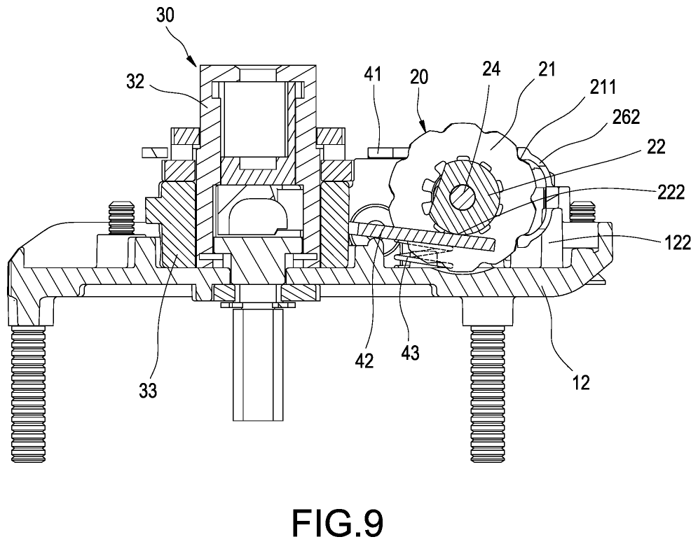

Please refer to FIGS. 7-10, which show a schematic plan view of the double-system lock of the disclosure when the number wheels are incorrect, a perspective schematic view of the internal structure of the double-system lock of the disclosure when the number wheels are incorrect and cross-sectional views of the internal structure of the double-system lock of the disclosure when the number wheels are incorrect. As shown in FIG. 7, when the number wheels 21 are rotated to an incorrect number combination, the round tab 222 of at least one wheel cylinder 22 touches the lock core control sheet 42 as shown in FIG. 9 to make the lock core control sheet 42 be pressed by the round tab 222 and rotate about the pair of shaft wheels 44. The frame plate 421 of the lock core control sheet 42 engages with a periphery of the lock seat 33 as shown in FIG. 8, the lock seat 33 is unrotatable, and the lock core 32 is unable to drive the lock seat 33 to rotate to make the double-system lock 1 in a lock state.

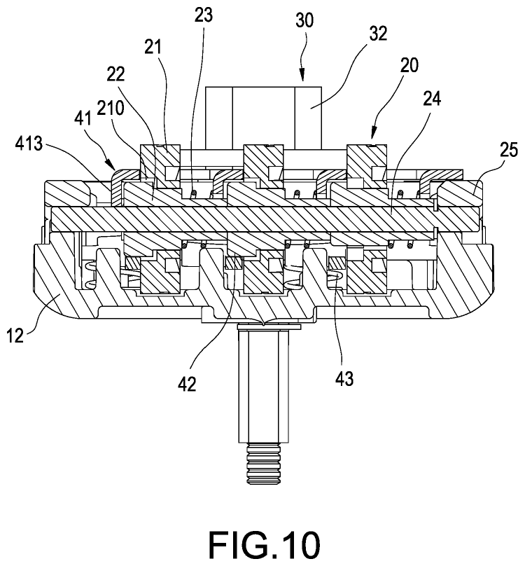

It is noted that, as shown in FIG. 10, when the double-system lock 1 of the disclosure is in a lock state, the main pushing rod 411 of the number wheel control sheet 41 is pushed by the lock core 32, and the secondary pushing rods 412 and the pushing portions 413 push the corresponding wheel cylinder 22 to make the rib 223 of the wheel cylinder 22 be embedded in the slot 210 of the corresponding number wheel 21.

While this disclosure has been described by means of specific embodiments, numerous modifications and variations could be made thereto by those skilled in the art without departing from the scope and spirit of this disclosure set forth in the claims.

What is claimed is:

1. A double-system lock structure comprising:
a lock case, comprising a panel and a base assembled with each other, and the panel comprising multiple windows;
a combination lock mechanism, installed on the base, comprising multiple number wheels, multiple wheel cylinders, multiple wheel cylinder springs and a wheel rod, the wheel cylinders penetrating through the number wheels, the number wheels arranged spacedly and partially exposed from the windows, the wheel rod penetrating through the wheel cylinders, the wheel cylinder springs separately pressing between the wheel cylinders, and each wheel cylinder comprising a plane portion and a round tab;
a key lock mechanism, comprising a lock seat and a lock core, the lock seat installed on the base, the lock core inserted in the lock seat and selectively driving the lock seat to rotate; and
a control sheet assembly, comprising a lock core control sheet, a support spring and a pair of shaft wheels, the lock core control sheet abutting against the lock seat and selectively touching the plane portion or the round tab of each wheel cylinder, the support spring elastically pressing a bottom of the lock core control sheet, the lock core control sheet comprising a pair of protrusive shafts passing through the pair of shaft wheels, wherein the lock core control sheet is configured to rotate about the pair of protrusive shafts to engage with the lock seat when the lock core control sheet touches the round tab of each wheel cylinder.

2. The double-system lock structure of claim 1, wherein the panel comprises a through hole, the key lock mechanism comprises a knob projecting from the through hole, and an end of the lock core is connected with the knob.

3. The double-system lock structure of claim 1, wherein the base comprises a pair of shaft seats, two ends of the wheel rod are disposed on the pair of shaft seats; and
the combination lock mechanism further comprises a pair of shaft covers, the pair of shaft covers cover two ends of the wheel rod and the pair of shaft wheels.

4. The double-system lock structure of claim 1, wherein the base comprises multiple support sheet seats, the combination lock mechanism further comprises a positioning sheet, the positioning sheet comprises an extended portion and multiple claw portions disposed spacedly on opposite sides of the extended portion, and the extended portion is disposed on the support sheet seats; and
multiple positioning notches are disposed equidistantly on a periphery of each number wheel, and the claw portions are selectively positioned on the positioning notches.

5. The double-system lock structure of claim 1, wherein each number wheel comprises multiple slots, each wheel cylinder comprises multiple ribs, each wheel cylinder is configured to make the ribs selectively engage with or separate from the slots of the number wheel being penetrated correspondingly through the wheel cylinder springs.

6. The double-system lock structure of claim 1, wherein the lock core control sheet comprises a frame plate surrounding the lock seat and multiple fingers horizontally extended from a side of the frame plate, and the fingers are extended to a bottom side of the wheel cylinder correspondingly.

7. The double-system lock structure of claim 6, wherein the lock core control sheet comprises a wheel trough disposed between the fingers adjacent to each other, and each number wheel is inserted in the wheel trough correspondingly.

8. The double-system lock structure of claim 6, wherein the protrusive shaft of the lock core control sheet is outward extended from opposite sides of the frame plate.

9. The double-system lock structure of claim 1, wherein the control sheet assembly further comprises a number control sheet, and the number control sheet abuts against the lock core and selectively presses each wheel cylinder spring.

10. The double-system lock structure of claim 9, wherein the number control sheet comprises a main pushing rod surrounding the lock core, multiple secondary pushing rods horizontally extended from a side of the main pushing rod and a pushing portion downward extended from each secondary pushing rod, and the pushing portion abuts against the wheel cylinder spring correspondingly.
